(19) United States
(12) Patent Application Publication
(10) Pub. No.: US 2023/0360631 A1
(43) Pub. Date: Nov. 9, 2023

(54) VOICE CONVERSION DEVICE, VOICE CONVERSION METHOD, AND VOICE CONVERSION PROGRAM

(71) Applicant: The University of Tokyo, Tokyo (JP)

(72) Inventors: Shinnosuke Takamichi, Tokyo (JP); Yuki Saito, Tokyo (JP); Takaaki Saeki, Tokyo (JP); Hiroshi Saruwatari, Tokyo (JP)

(21) Appl. No.: 17/636,617

(22) PCT Filed: Aug. 18, 2020
(86) PCT No.: PCT/JP20/31122

§ 371 Date: Feb. 18, 2022

(30) Foreign Application Priority Data
Aug. 19, 2019 (JP) 2019-149939

(51) Int. Cl. G10L 13/02; G10L 25/30

(52) U.S. Cl. CPC G10L 13/02; G10L 25/30

(57) ABSTRACT

A voice conversion device and so forth, capable of realizing both high voice quality and real-time nature using spectral differentials, are provided. The voice conversion device 10 includes an acquisition unit 11 that acquires signals of a voice of a subject, a filter calculation unit 12 that performs transform of features representing a voice timbre of the voice by a trained transformer model, and subjects the features following transform to liftering by a trained lifter, thereby calculating a spectrum of a filter, a shortened filter calculation unit 13 that performs inverse Fourier transform of the spectrum of the filter, and applies a predetermined window function, thereby calculating a shortened filter, and a generating unit 14 that applies a spectrum, obtained by Fourier transform of the shortened filter, to the spectrum of the signals, and performs inverse Fourier transform, thereby generating a synthesized voice.

### CROSS-REFERENCE OF RELATED APPLICATION

This application claims priority to Japanese Patent Application No. 2019-149939 filed on Aug. 19, 2019, incorporated herein by reference in its entirety.

### TECHNICAL FIELD

The present invention relates to a voice conversion device, a voice conversion method, and a voice conversion program.

### BACKGROUND ART

There conventionally has been research performed regarding converting the voice of a subject and generating a synthesized voice as if someone else were speaking. For example, NPL 1 and 2 below describe technology of estimating a filter equivalent to the difference between an envelope spectrum component of a subject serving as a conversion source, and an envelope spectrum component of a conversion destination speaker, and applying this filter to the voice of the subject, thereby generating synthesized voice of the conversion destination.

According to NPL 1 and 2, with regard to filter design, using a minimum phase filter enables higher voice quality to be achieved as compared with conventionally used MLSA (Mel-Log Spectrum Approximation).

### CITATION LIST

### Non-Patent Document

Non-Patent Document 1: Kazuhiro Kobayashi, Tomoki Toda and Satoshi Nakamura, “Intra-gender statistical singing voice conversion with direct waveform modification using log-spectral differential,” Speech Communication, Volume 99, May 2018, Pages 211-220.
Non-Patent Document 2: Hitoshi Suda, Gaku Kotani, Shinnosuke Takamichi, and Daisuke Saito, “A Revisit to Feature Handling for High-quality Voice Conversion Based on Gaussian Mixture Model,” Proceedings, APSIPA Annual Summit and Conference 2018.

### SUMMARY OF INVENTION

### Technical Problem

However, minimum phase filters require a relatively great calculation amount for filter calculation, and accordingly application to real-time voice conversion has been difficult. Now, cutting part of the filter to reduce the calculation amount is conceivable, but the precision of the filter will deteriorate, and accordingly the quality of the synthesized voice often deteriorates.

Accordingly, the present invention provides a voice conversion device, a voice conversion method, and a voice conversion program, capable of realizing both high voice quality and real-time nature using spectral differentials.

### Solution to Problem

A voice conversion device according to an aspect of the present invention includes: an acquisition unit that acquires signals of a voice of a subject; a filter calculation unit that performs transform of features representing a voice timbre of the voice by a trained transformer model, and subjects the features following transform to liftering by a trained lifter, thereby calculating a spectrum of a filter; a shortened filter calculation unit that performs inverse Fourier transform of the spectrum of the filter, and applies a predetermined window function, thereby calculating a shortened filter; and a generating unit that applies a spectrum, obtained by Fourier transform of the shortened filter, to the spectrum of the signals, and performs inverse Fourier transform, thereby generating a synthesized voice.

According to this aspect, in addition to performing transform of features by the trained transformer model, the shortened filter is calculated using the trained lifter, thereby realizing voice conversion in which both high voice quality and real-time nature can be realized using spectral differentials.

The above aspect may further include a learning unit that applies a spectrum obtained by Fourier transform of the shortened filter to the spectrum of signals, calculates features representing the voice timbre of the synthesized voice, and updates the parameters of the transformer model and lifter to reduce the error between the features and features representing the voice timbre of a target voice, thereby generating the trained transformer model and the trained lifter.

According to this aspect, generating the trained transformer model and the trained lifter in this way enables effects of the shortened filter obtained by cutting the filter to be suppressed, and high-quality voice conversion can be performed even with a shorter filter.

In the above aspect, the transformer model may be configured of a neural network, and the learning unit may update the parameters by backpropagation, thereby generating the trained transformer model and the trained lifter.

In the above aspect, the features may be a mel-frequency cepstrum of the voice.

According to this aspect, the voice timbre of the voice of the subject can be appropriately captured.

A voice conversion method according to another aspect of the present invention includes: acquiring signals of a voice of a subject; performing transform of features representing a voice timbre of the voice by a trained transformer model, and subjecting the features following transform to liftering by a trained lifter, thereby calculating a spectrum of a filter; performing inverse Fourier transform of the spectrum of the filter, and applying a predetermined window function, thereby calculating a shortened filter; and applying a spectrum, obtained by Fourier transform of the shortened filter, to the spectrum of the signals, and performing inverse Fourier transform, thereby generating a synthesized voice.

According to this aspect, in addition to performing transform of features by the trained transformer model, the shortened filter is calculated using the trained lifter, thereby realizing voice conversion in which both high voice quality and real-time nature can be realized using spectral differentials.

A voice conversion program according to another aspect of the present invention causes a computer provided to a voice conversion device to function as an acquisition unit that acquires signals of a voice of a subject, a filter calculation unit that performs transform of features representing a voice timbre of the voice by a trained transformer model, and subjects the features following transform to liftering by a trained lifter, thereby calculating a spectrum of a filter, a shortened filter calculation unit that performs inverse Fourier transform of the spectrum of the filter, and applies a predetermined window function, thereby calculating a shortened filter, and a generating unit that applies a spectrum, obtained by Fourier transform of the shortened filter, to the spectrum of the signals, and performs inverse Fourier transform, thereby generating a synthesized voice.

According to this aspect, in addition to performing transform of features by the trained transformer model, the shortened filter is calculated using the trained lifter, thereby realizing voice conversion in which both high voice quality and real-time nature can be realized using spectral differentials.

### Advantageous Effects of Invention

According to the present invention, a voice conversion device, a voice conversion method, and a voice conversion program, capable of realizing both high voice quality and real-time nature using spectral differentials, can be provided.

### BRIEF DESCRIPTION OF DRAWINGS

FIG. 1 is a diagram illustrating functional blocks of a voice conversion device according to an embodiment of the present invention.

FIG. 2 is a diagram illustrating a physical configuration of the voice conversion device according to the present embodiment.

FIG. 3 is a diagram illustrating an overview of processing executed by the voice conversion device according to the present embodiment.

FIG. 4 is a diagram showing a relation between error in synthesized voice generated by each of the voice conversion device according to the present embodiment and a device according to a conventional example, and filter length.

FIG. 5 is a diagram showing results of subjective evaluation relating to speaker similarity of synthesized voice generated by each of the voice conversion device according to the present embodiment and the device according to the conventional example.

FIG. 6 is a diagram showing results of subjective evaluation relating to voice quality of synthesized voice generated by each of the voice conversion device according to the present embodiment and the device according to the conventional example.

FIG. 7 is a diagram showing results of subjective evaluation relating to relation between speaker similarity of synthesized voice generated by the voice conversion device according to the present embodiment and filter length.

FIG. 8 is a diagram showing results of subjective evaluation relating to relation between voice quality of synthesized voice generated by the voice conversion device according to the present embodiment and filter length.

FIG. 9 is a flowchart of voice conversion processing executed by the voice conversion device according to the present embodiment.

FIG. 10 is a flowchart of learning processing executed by the voice conversion device according to the present embodiment.

### DESCRIPTION OF EMBODIMENTS

An embodiment of the present invention will be described with reference to the attached Figures. Note that in the Figures, items denoted by the same signs have the same or similar configurations.

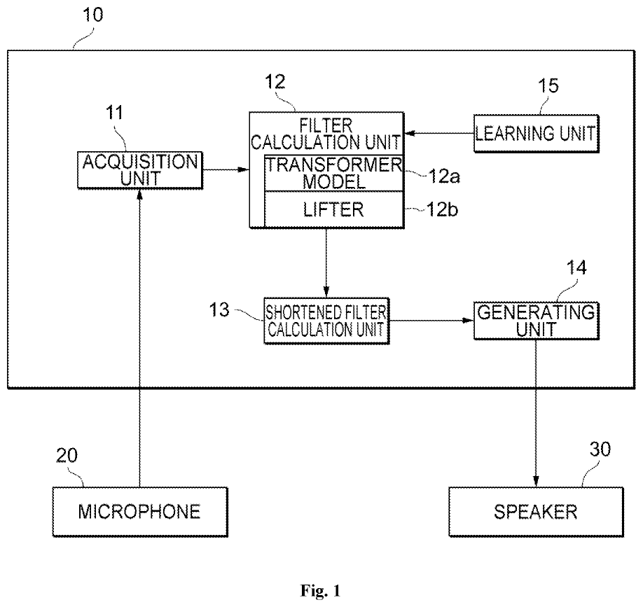

FIG. 1 is a diagram illustrating functional blocks of a voice conversion device 10 according to the embodiment of the present invention. The voice conversion device 10 is provided with an acquisition unit 11, a filter calculation unit 12, a shortened filter calculation unit 13, a generating unit 14, and a learning unit 15.

The acquisition unit 11 acquires signals of voice of a subject. The acquisition unit 11 acquires the voice of the subject converted into electric signals by a microphone 20 over a predetermined period. Hereinafter, a complex spectral sequence in which signals of the voice of the subject are subjected to Fourier transform will be represented as F^{(X)}=[F₁^{(X)}, . . . , F_{T}^{(X)}]. T here is the number of frames during the predetermined period.

The filter calculation unit 12 performs transform of features representing the voice timbre of voice by a trained transformer model 12a and subjects the features following transform to liftering by a trained lifter 12b, thereby calculating a spectrum of the filter. The features representing the voice timbre of voice may be the mel-frequency cepstrum of the voice. Using the mel-frequency cepstrum as the features enables the voice timbre of the voice of the subject to be appropriately captured.

The filter calculation unit 12 calculates a low-order (e.g., 10 to 100 order) real cepstrum sequence C^{(X)}=[C₁^{(X)}, . . . , C_{T}^{(X)}] from the complex spectral sequence F^{(X)} in which signals of the voice of the subject have been subjected to Fourier transform. The filter calculation unit 12 then performs transform of the real cepstrum sequence C^{(X)} by the trained transformer model 12a, thereby calculating features C^{(D)}=[C₁^{(D)}, . . . , C_{T}^{(D)}] following transform.

Further, the filter calculation unit 12 performs liftering of the features C^{(D)}=[C₁^{(D)}, . . . , C_{T}^{(D)}] following transform using the trained lifter 12b, thereby calculating the spectrum of the filter. More specifically, when expressing the trained lifter 12b as [u₁, . . . , u_{T}], the filter calculation unit 12 calculates a product [u₁C₁^{(D)}, . . . , u_{T}C_{T}^{(D)}], and performs Fourier transform, thereby calculating a complex spectral sequence F^{(D)}=[F₁^{(D)}, . . . , F_{T}^{(D)}] of the filter.

In a case of generating a minimum phase filter, a lifter expressed by the following Expression (1) is used. N here is the frequency bin count.

$${u}_{min} ( n ) = \{ \begin{matrix}1 & ( n = 0 , n = N / 2 ) \\ 2 & ( 0 < n < N / 2 ) \\ 0 & ( n > N / 2 )\end{matrix}$$

In contrast, the values of the trained lifter 12b used in the voice conversion device 10 according to the present embodiment differ from those in Expression (1), and are values set by later-described learning processing. In the learning processing, the values of the lifter 12b are updated along with the parameters of the transformer model 12a, and are decided so as to represent the target voice better by the synthesized voice.

The shortened filter calculation unit 13 performs inverse Fourier transform of the spectrum of the filter, and applies a predetermined window function, thereby calculating a shortened filter. More specifically, the shortened filter calculation unit 13 performs inverse Fourier transform of the spectrum F^{(D)} of the filter, performs cutting by applying a window function in which the temporal region value is 1 before a time t and is 0 after the time t, and performs Fourier transform, thereby calculating a complex spectral sequence F^{(I)}=[F₁^{(I)}, . . . , F_{T}^{(I)}] of the shortened filter.

The generating unit 14 applies a spectrum, obtained by Fourier transform of the shortened filter, to the spectrum of the signals, and performs inverse Fourier transform, thereby generating synthesized voice. The generating unit 14 calculates F^{(Y)}=[F₁^{(X)}F₁^{(I)}, . . . , F_{T}^{(X)}F_{T}^{(I)}], which is the product of the Fourier-transformed spectrum F^{(I)}=[F₁^{(I)}, . . . , F_{T}^{(I)}] of the shortened filter and the spectrum F^{(X)}=[F₁^{(X)}, . . . , F_{T}^{(X)}] of signals of the voice of the subject, and performs inverse Fourier transform of the spectrum F^{(Y)}, thereby generating the synthesized voice.

The learning unit 15 applies the spectrum obtained by Fourier transform of the shortened filter to the spectrum of signals of the voice of the subject, calculates features representing the voice timbre of the synthesized voice, and updates the parameters of the transformer model and lifter to reduce the error between these features and the features representing the voice timbre of the target voice, thereby generating the trained transformer model and the trained lifter. In the present embodiment, the transformer model 12a is configured of a neural network. The transformer model 12a may be configured of, for example, an MLP (Multi-Layer Perceptron) using a Gated Linear Unit as an activation function in a hidden layer, and applying Batch Normalization prior to the activation functions.

The learning unit 15 calculates the spectrum F^{(I)} obtained by Fourier transform of the shortened filter by the transformer model 12a and the lifter 12b regarding which the parameters are indeterminate, and applies to the spectrum F^{(X)} of signals of the voice of the subject to calculate the spectrum F^{(Y)}, thereby calculating mel-frequency cepstrum C^{(Y)}=[C₁^{(Y)}, . . . , C_{T}^{(Y)}] as features. The error between the calculated cepstrum C^{(Y)}=[C₁^{(Y)}, . . . , C_{T}^{(Y)}] and the cepstrum C^{(T)}=[C₁^{(T)}, . . . , C_{T}^{(T)}] that is the target voice serving as learning data is then calculated by L=(C^{(T)}−C^{(Y)})^{T}(C^{(T)}−C^{(Y)})/T. Hereinafter, the value of √L will be referred to as RMSE (Rooted Mean Squared Error).

The learning unit 15 performs partial differentiation of the error L=(C^{(T)}−C^{(Y)})^{T}(C^{(T)}−C^{(Y)})/T by the parameters of the transformer model and the lifter, and updates the parameters of the transformer model and the lifter by backpropagation. Note that the learning processing may be performed using Adam (Adaptive moment estimation), for example. Generating the trained transformer model 12a and the trained lifter 12b in this way enables effects of the shortened filter obtained by cutting the filter to be suppressed, and high-quality voice conversion can be performed even with a shorter filter.

According to the voice conversion device 10 of the present embodiment, not only is transform of features performed by the trained transformer model 12a, but also the shortened filter is calculated using the trained lifter 12b, thereby realizing voice conversion capable of realizing both high voice quality and real-time nature using spectral differentials.

According to the voice conversion device 10 of the present embodiment, with the length of the shortened filter at ⅛ that of the conventional, for example, the calculation amount of filter processing can be reduced to around 1% of that of the conventional. Accordingly, voice signals acquired at a sampling rate around 44.1 kHz, for example, can be converted into a target voice in a processing time no longer than 50 ms.

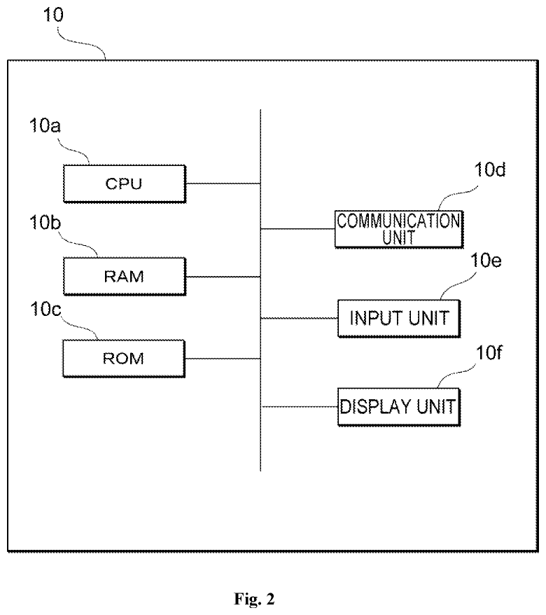

FIG. 2 is a diagram illustrating the physical configuration of the voice conversion device 10 according to the present embodiment. The voice conversion device 10 includes a CPU (Central Processing Unit) 10a that is equivalent to a computing unit, RAM (Random Access Memory) 10b that is equivalent to a storage unit, ROM (Read only Memory) 10c that is equivalent to a storage unit, a communication unit 10d, an input unit 10e, and a display unit 10f. These configurations are connected via a bus so as to be capable of exchanging data with each other. Note that while description will be made in this example regarding a case in which the voice conversion device 10 is configured of a single computer, the voice conversion device 10 may be realized as a combination of a plurality of computers. Also, the configuration illustrated in FIG. 2 is exemplary, and the voice conversion device 10 may have configurations other than these, or alternatively, may be without part of these configurations.

The CPU 10a is a control unit that performs control regarding programs stored in the RAM 10b or the ROM 10c, and computes and processes data. The CPU 10a is a computing unit that executes a program (voice conversion program) for calculating a plurality of features relating to voice of the subject, converting the plurality of features into a plurality of converted features corresponding to the target voice, and generating synthesized voice on the basis of the plurality of converted features. The CPU 10a receives various types of data from the input unit 10e and the communication unit 10d, with data computation results being displayed on the display unit 10f or stored in the RAM 10b.

The RAM 10b is a part of the storage unit of which data can be rewritten, and may be configured of a semiconductor storage device, for example. The RAM 10b may store programs that the CPU 10a executes, and data such as voice of subjects, target voices, and so forth. Note that these are exemplary, and the RAM 10b may store data other than these, or may not store part thereof.

The ROM 10c is a part of the storage unit from which data can be read out, and may be configured of a semiconductor storage device, for example. The ROM 10c may store the voice conversion program and data that is not rewritten, for example.

The communication unit 10d is an interface for connecting the voice conversion device 10 to other equipment. The communication unit 10d may be connected to a communication network such as the Internet or the like.

The input unit 10e accepts input of data from users, and may include a keyboard and a touch panel, for example.

The display unit 10f is for visually displaying computation results by the CPU 10a, and may be configured of an LCD (Liquid Crystal Display), for example. The display unit 10f may display waveforms of voices of subjects, and may display waveforms of synthesized voices.

The voice conversion program may be provided stored in a computer-readable storage medium such as the RAM 10b or ROM 10c, or may be provided via a communication network to which connection is performed by the communication unit 10d. The various operations described with reference to FIG. 1 are realized in the voice conversion device 10, by the CPU 10a executing the voice conversion program. Note that these physical configurations are exemplary, and do not necessarily have to be independent configurations. For example, the voice conversion device 10 may be provided with an LSI (Large-Scale Integration) in which the CPU 10a, the RAM 10b, and the ROM 10c are integrated.

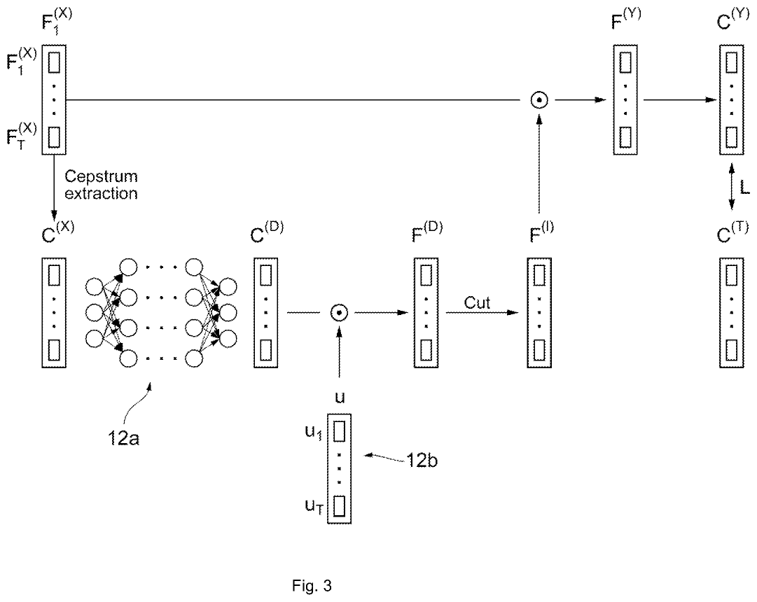

FIG. 3 is a diagram illustrating an overview of processing executed by the voice conversion device 10 according to the present embodiment. The voice conversion device 10 acquires signals of the voice of the subject, and calculates a Fourier-transformed complex spectral sequence F^{(X)}=[F₁^{(X)}, . . . , F_{T}^{(X)}]. The actual cepstrum sequence C^{(X)}=[C₁^{(X)}, . . . , C_{T}^{(X)}] is then calculated from the complex spectral sequence F^{(X)} and input to the trained transformer model 12a. In this Figure, the transformer model 12a is represented by a schematic diagram of a neural network.

The voice conversion device 10 subjects the features C^{(D)}=[C₁^{(D)}, . . . , C_{T}^{(D)}] following transform to liftering by the trained lifter 12b [u₁, . . . , u_{T}] and performs Fourier transform, thereby calculating the complex spectral sequence F^{(D)}=[F₁^{(D)}, . . . , F_{T}^{(D)}] of the filter.

Thereafter, the voice conversion device 10 performs inverse Fourier transform of the complex spectral sequence F^{(D)}=[F₁^{(D)}, . . . , F_{T}^{(D)}] of the filter and yields temporal region values, which are cut by applying a window function in which the temporal region value is 1 before a time t and is 0 after the time t, and performs Fourier transform, thereby calculating a complex spectral sequence F^{(I)}=[F₁^{(I)}, . . . , F_{T}^{(I)}] of the shortened filter.

The voice conversion device 10 applies the complex spectral sequence F^{(I)}=[F₁^{(I)}, . . . , F_{T}^{(I)}] of the shortened filter calculated in this way to the spectrum F^{(X)}=[F₁^{(X)}, . . . , F_{T}^{(X)}] of signals of the voice of the subject, thereby, and calculates the spectrum F^{(Y)}=[F₁^{(X)}F₁^{(I)}, . . . , F_{T}^{(X)}F_{T}^{(I)}] of the synthesized voice. The voice conversion device 10 performs inverse Fourier transform of the spectrum F^{(Y)} of the synthesized voice, thereby generating the synthesized voice.

In a case of performing learning processing of the transformer model 12a and the lifter 12b, the actual cepstrum sequence C^{(Y)}=[C₁^{(Y)}, . . . , C_{T}^{(Y)}] is calculated from the spectrum F^{(Y)} of the synthesized voice, and calculates the error as to the cepstrum C^{(T)}=[C₁^{(T)}, . . . , C_{T}^{(T)}] that is the target voice serving as learning data by L=(C^{(T)}−C^{(Y)})^{T}(C^{(T)}−C^{(Y)})/T. The parameters of the transformer model 12a and the lifter 12b are then updated by backpropagation.

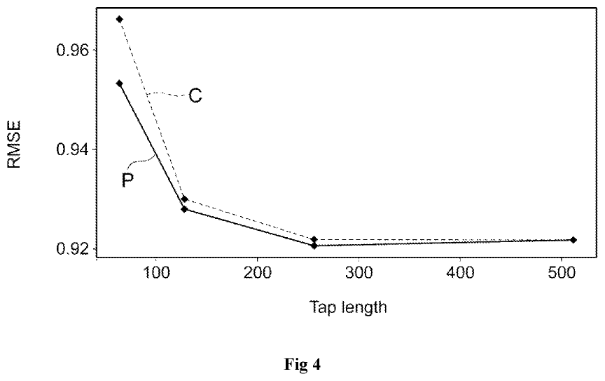

FIG. 4 is a diagram showing the relation between the error in synthesized voices generated by each of the voice conversion device 10 according to the present embodiment and a device according to a conventional example, and the filter length. In this Figure, a first graph P representing the relation between the RMSE (value of √L) of the synthesized voice generated by the voice conversion device 10 according to the present embodiment and the filter length (Tap length) is indicated by a solid line, and a second graph C representing the relation between the RMSE of the synthesized voice generated by the device according to the conventional example and the filter length is indicated by a dashed line.

The filter length here is 512 at the maximum (in a case of using a window function in which all times are 1). In this Figure, the RMSE values are plotted for cases in which the filter lengths are 512, 256, 128, and 64.

According to the first graph P and the second graph C, the RMSE of the synthesized voice generated by the voice conversion device 10 according to the present embodiment is smaller than the RMSE of the synthesized voice generated by the device according to the conventional example, over the entire range of the filter length. The degree of improvement is particularly marked in cases in which the filter length is short. In this way, effects on voice quality of shortening the filter length can be reduced by the voice conversion device 10 according to the present embodiment.

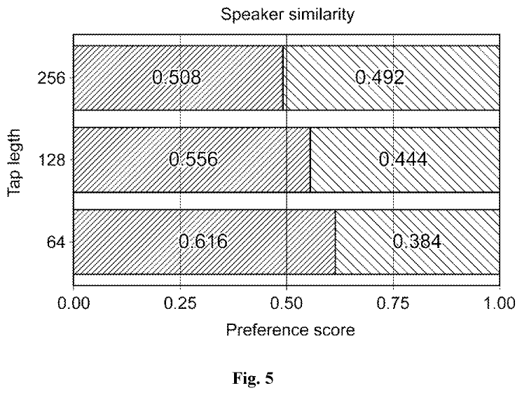

FIG. 5 is a diagram showing the results of subjective evaluation relating to speaker similarity of synthesized voice generated by each of the voice conversion device 10 according to the present embodiment and the device according to the conventional example. The results of subjective evaluation relating to speaker similarity are the results of having a plurality of examiners listen to and compare synthesized voice generated by the voice conversion device 10 according to the present embodiment, synthesized voice generated by the device according to the conventional example, and the target voice (correct voice), and evaluate which of the present embodiment and the conventional example is more similar to the target voice. In this Figure, the vertical axis represents the filter length (Tap length), and the horizontal axis represents the percentage of evaluations of similarity to the target voice (Preference score). In the graph, The Preference score of the voice conversion device 10 according to the present embodiment is shown to the left, and the Preference score of the device according to the conventional example is shown to the right.

In a case of a Tap length of 256, i.e., in a case in which the filter length was halved, the Preference score of the present embodiment was 0.508, and the Preference score of the conventional example was 0.942. In a case of a Tap length of 128, i.e., in a case in which the filter length was ¼, the Preference score of the present embodiment was 0.556, and the Preference score of the conventional example was 0.444. In a case of a Tap length of 64, i.e., in a case in which the filter length was ⅛, the Preference score of the present embodiment was 0.616, and the Preference score of the conventional example was 0.384.

In this way, the shorter the filter length was, the more similar the synthesized voice generated by the voice conversion device 10 according to the present embodiment was evaluated to be to the target voice as compared with the synthesized voice generated by the device according to the conventional example. Note that the p-value relating to this evaluation was 1.55×10⁻⁷.

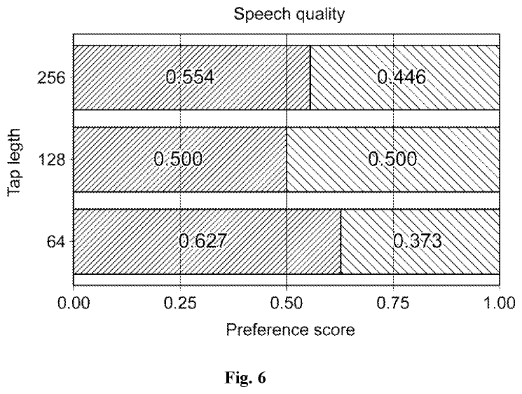

FIG. 6 is a diagram showing the results of subjective evaluation relating to voice quality of synthesized voice generated by each of the voice conversion device 10 according to the present embodiment and the device according to the conventional example. The results of subjective evaluation relating to voice quality are the results of having a plurality of examiners listen to and compare synthesized voice generated by the voice conversion device 10 according to the present embodiment and synthesized voice generated by the device according to the conventional example, and evaluate which of the present embodiment and the conventional example is a voice that sounds more natural. In this Figure, the vertical axis represents the filter length (Tap length), and the horizontal axis represents the percentage of evaluations of superior voice quality (Preference score). In the graph, The Preference score of the voice conversion device 10 according to the present embodiment is shown to the left, and the Preference score of the device according to the conventional example is shown to the right.

In a case of a Tap length of 256, i.e., in a case in which the filter length was halved, the Preference score of the present embodiment was 0.554, and the Preference score of the conventional example was 0.446. In a case of a Tap length of 128, i.e., in a case in which the filter length was ¼, the Preference score of the present embodiment was 0.500, and the Preference score of the conventional example was 0.500. In a case of a Tap length of 64, i.e., in a case in which the filter length was ⅛, the Preference score of the present embodiment was 0.627, and the Preference score of the conventional example was 0.373.

In this way, the shorter the filter length was, the more similar the synthesized voice generated by the voice conversion device 10 according to the present embodiment was evaluated to be to the target voice as compared with the synthesized voice generated by the device according to the conventional example. Note that the p-value relating to this evaluation was 4.33×10⁻⁹.

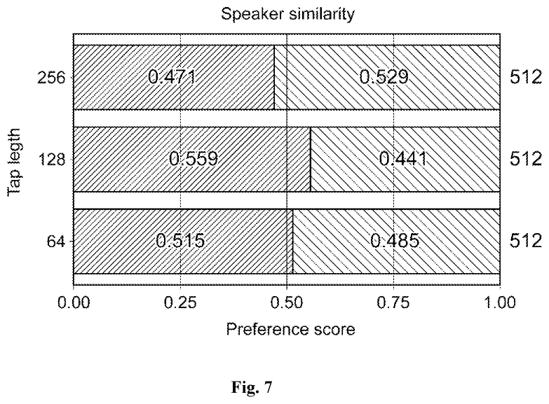

FIG. 7 is a diagram showing the results of subjective evaluation relating to the relation between speaker similarity of synthesized voice generated by the voice conversion device 10 according to the present embodiment and filter length. The results of this evaluation are the results of having a plurality of examiners listen to and compare synthesized voice generated by the voice conversion device 10 according to the present embodiment without shortening the filter length (Tap length of 512), and synthesized voice generated by the voice conversion device 10 according to the present embodiment with the filter length shortened (Tap length of 256, 128, and 64), and evaluate which is more similar to a target voice. In this Figure, the vertical axis represents the filter length (Tap length), and the horizontal axis represents the percentage of evaluations of similarity to the target voice (Preference score). In the graph, The Preference score of the case of shortening the filter length is shown to the left, and the Preference score of the case of not shortening the filter length is shown to the right.

In comparison between a case of a Tap length of 256 and a case of a Tap length of 512, the Preference score in the case of the Tap length of 256 was 0.471, and the Preference score in the case of the Tap length of 512 was 0.529. In comparison between a case of a Tap length of 128 and a case of a Tap length of 512, the Preference score in the case of the Tap length of 128 was 0.559, and the Preference score in the case of the Tap length of 512 was 0.441. Also, in comparison between a case of a Tap length of 64 and a case of a Tap length of 512, the Preference score in the case of the Tap length of 64 was 0.515, and the Preference score in the case of the Tap length of 512 was 0.485.

In this way, even when the filter length was shortened, the synthesized voice generated by the voice conversion device 10 according to the present embodiment was evaluated to be similar to the target voice at around the same degree as a case of not shortening the filter length. Note that the p-value relating to this evaluation was no less than 0.05.

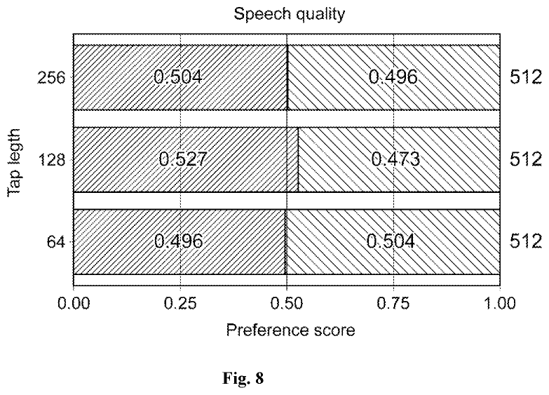

FIG. 8 is a diagram showing the results of subjective evaluation relating to the relation between voice quality of synthesized voice generated by the voice conversion device 10 according to the present embodiment and filter length. The results of this evaluation are the results of having a plurality of examiners listen to and compare synthesized voice generated by the voice conversion device 10 according to the present embodiment without shortening the filter length (Tap length of 512), and synthesized voice generated by the voice conversion device 10 according to the present embodiment with the filter length shortened (Tap length of 256, 128, and 64), and evaluate which is a voice that sounds more natural. In this Figure, the vertical axis represents the filter length (Tap length), and the horizontal axis represents the percentage of evaluations of similarity to the target voice (Preference score). In the graph, The Preference score of the case of shortening the filter length is shown to the left, and the Preference score of the case of not shortening the filter length is shown to the right.

In comparison between a case of a Tap length of 256 and a case of a Tap length of 512, the Preference score in the case of the Tap length of 256 was 0.504, and the Preference score in the case of the Tap length of 512 was 0.496. In comparison between a case of a Tap length of 128 and a case of a Tap length of 512, the Preference score in the case of the Tap length of 128 was 0.527, and the Preference score in the case of the Tap length of 512 was 0.473. Also, in comparison between a case of a Tap length of 64 and a case of a Tap length of 512, the Preference score in the case of the Tap length of 64 was 0.496, and the Preference score in the case of the Tap length of 512 was 0.504.

In this way, even when the filter length was shortened, the synthesized voice generated by the voice conversion device 10 according to the present embodiment was evaluated to sound natural at around the same degree as a case of not shortening the filter length. Note that the p-value relating to this evaluation was no less than 0.05.

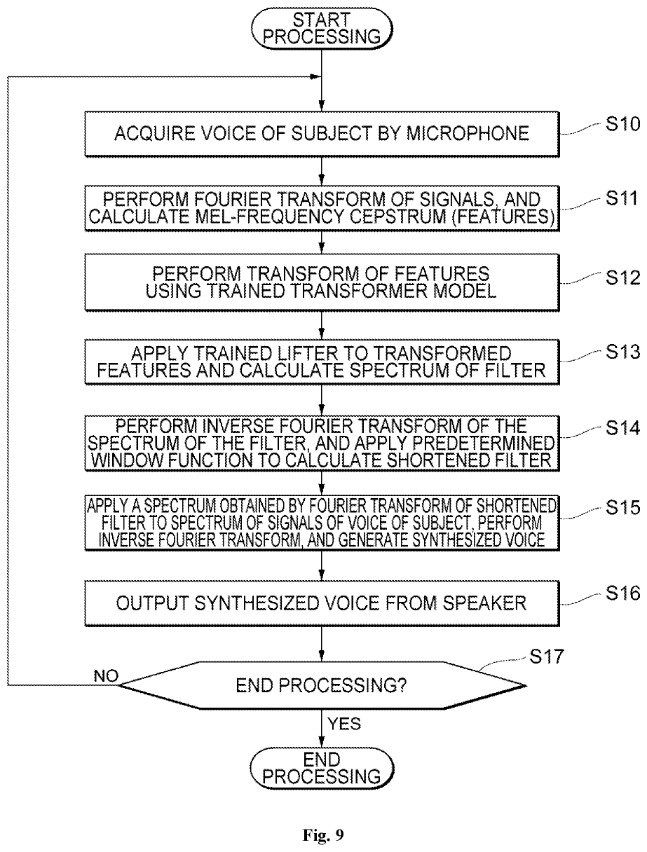

FIG. 9 is a flowchart of voice conversion processing executed by the voice conversion device 10 according to the present embodiment. To begin with, the voice conversion device 10 acquires the voice of a subject by the microphone 20 (S10).

Thereafter, the voice conversion device 10 performs Fourier transform on signals of the voice of the subject and calculates a mel-frequency cepstrum (features) (S11), and performs transform of the features by the trained transformer model 12a (S12).

The voice conversion device 10 further applies the trained lifter 12b to the features following transform, thereby calculating a spectrum of a filter (S13), performs inverse Fourier transform of the spectrum of the filter, and applies a predetermined window function to calculate a shortened filter (S14).

The voice conversion device 10 then applies a spectrum obtained by Fourier transform of the shortened filter to the spectrum of the signals of the voice of the subject, and performs inverse Fourier transform, thereby generating synthesized voice (S15). The voice conversion device 10 outputs the generated synthesized voice from a speaker (S16).

In a case of not ending voice conversion processing (S17: NO), the voice conversion device 10 executes the processing of S10 to S16 again. Conversely, in a case of ending voice conversion processing (S17: YES), the voice conversion device 10 ends the processing.

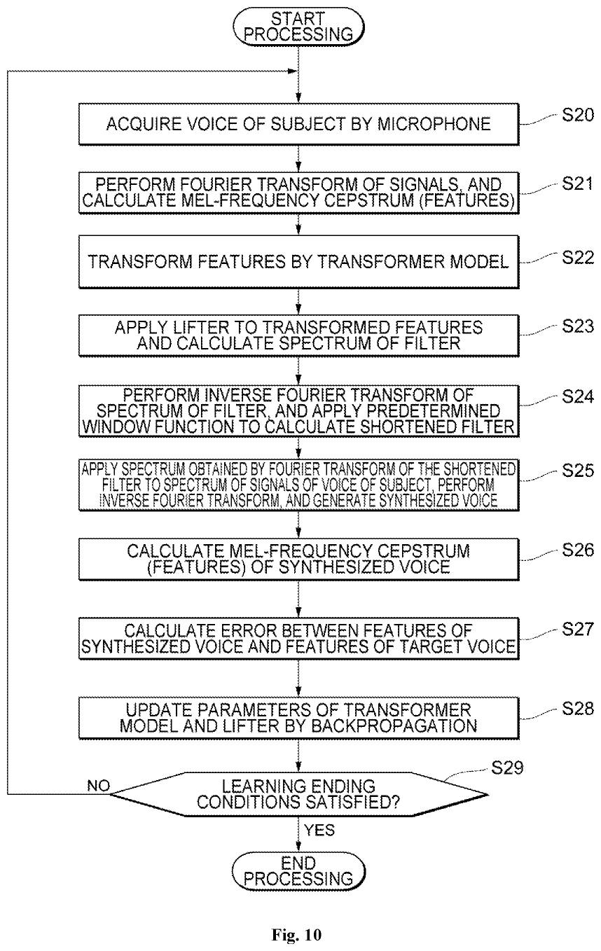

FIG. 10 is a flowchart of learning processing executed by the voice conversion device 10 according to the present embodiment. To begin with, the voice conversion device 10 acquires the voice of a subject by the microphone 20 (S20). Note that the voice conversion device 10 may acquire signals of voice recorded in advance.

Thereafter, the voice conversion device 10 performs Fourier transform on signals of the voice of the subject and calculates a mel-frequency cepstrum (features) (S21), and performs transform of the features by the transformer model 12a that is in training (S22).

The voice conversion device 10 further applies the lifter 12b that is in training to the features following transform, thereby calculating a spectrum of a filter (S23), performs inverse Fourier transform of the spectrum of the filter, and applies a predetermined window function to calculate a shortened filter (S24).

The voice conversion device 10 then applies a spectrum obtained by Fourier transform of the shortened filter to the spectrum of the signals of the voice of the subject, and performs inverse Fourier transform, thereby generating synthesized voice (S25).

Thereafter, the voice conversion device 10 calculates a mel-frequency cepstrum (features) of the synthesized voice (S26), and calculates the error between the features of the synthesized voice and the features of the target voice (S27). The voice conversion device 10 then updates the parameters of the transformer model 12a and the lifter 12b by backpropagation (S28).

In a case in which learning ending conditions are not satisfied (S29: NO), the voice conversion device 10 executes the processing of S20 to S28 again. Conversely, in a case in which learning ending conditions are satisfied (S29: YES), the voice conversion device 10 ends the processing. Note that the learning ending conditions may be that the error between the features of the synthesized voice and the features of the target value is no greater than a predetermined value, or that the epochs of learning processing reach a predetermined count, or the like.

The embodiment described above is for facilitating understanding of the present invention, and is not intended to restrictively interpret the present invention. The components included in the embodiment, and the layout, materials, conditions, shapes, sizes, and so forth thereof are not limited to those exemplified, and can be changed as appropriate. Also, configurations shown in different embodiments can be partially replaced or combined with each other.

### REFERENCE SIGNS LIST

10 Voice conversion device
10a CPU
10b RAM
10c ROM
10d Communication unit
10e Input unit
10f Display unit
11 Acquisition unit
12 Filter calculation unit
12a Transformer model
12b Lifter
13 Shortened filter calculation unit
14 Generating unit
15 Learning unit
20 Microphone
30 Speaker

1. A voice conversion device, comprising:
an acquisition unit that acquires signals of a voice of a subject;
a filter calculation unit that performs transform of features representing a voice timbre of the voice by a trained transformer model, and subjects the features following transform to liftering by a trained lifter, thereby calculating a spectrum of a filter;
a shortened filter calculation unit that performs inverse Fourier transform of the spectrum of the filter, and applies a predetermined window function, thereby calculating a shortened filter; and
a generating unit that applies a spectrum, obtained by Fourier transform of the shortened filter, to the spectrum of the signals, and performs inverse Fourier transform, thereby generating a synthesized voice.

2. The voice conversion device according to claim 1, further comprising:
a learning unit that applies a spectrum obtained by Fourier transform of the shortened filter to the spectrum of signals, calculates features representing the voice timbre of the synthesized voice, and updates the parameters of the transformer model and lifter to reduce the error between the features and features representing the voice timbre of a target voice, thereby generating the trained transformer model and the trained lifter.

3. The voice conversion device according to claim 2, wherein
the transformer model is configured of a neural network, and
the learning unit updates the parameters by backpropagation, thereby generating the trained transformer model and the trained lifter.

4. A voice conversion method, comprising:
acquiring signals of a voice of a subject;
performing transform of features representing a voice timbre of the voice by a trained transformer model, and subjecting the features following transform to liftering by a trained lifter, thereby calculating a spectrum of a filter;
performing inverse Fourier transform of the spectrum of the filter, and applying a predetermined window function, thereby calculating a shortened filter; and
applying a spectrum, obtained by Fourier transform of the shortened filter, to the spectrum of the signals, and performing inverse Fourier transform, thereby generating a synthesized voice.

5. A voice conversion program that causes a computer provided to a voice conversion device to function as
an acquisition unit that acquires signals of a voice of a subject,
a filter calculation unit that performs transform of features representing a voice timbre of the voice by a trained transformer model, and subjects the features following transform to liftering by a trained lifter, thereby calculating a spectrum of a filter,
a shortened filter calculation unit that performs inverse Fourier transform of the spectrum of the filter, and applies a predetermined window function, thereby calculating a shortened filter, and
a generating unit that applies a spectrum, obtained by Fourier transform of the shortened filter, to the spectrum of the signals, and performs inverse Fourier transform, thereby generating a synthesized voice.
